(19) United States
(12) Patent Application Publication
(10) Pub. No.: US 2013/0244017 A1
(43) Pub. Date: Sep. 19, 2013

(54) PLASTISOL FOR SPRAY-MOLDED PLASTIC ARTICLES

(71) Applicants: John Tresino, Findlay, OH (US); Brent Cassata, Findlay, OH (US); Stephen D. Horton, Avon, OH (US)

(72) Inventors: John Tresino, Findlay, OH (US); Brent Cassata, Findlay, OH (US); Stephen D. Horton, Avon, OH (US)

(73) Assignee: POLYONE CORPORATION, Avon Lake, OH (US)

(21) Appl. No.: 13/990,969

(22) PCT Filed: Nov. 30, 2011
(86) PCT No.: PCT/US2011/062679

§ 371 Date: May 31, 2013

Related U.S. Application Data
(60) Provisional application No. 61/419,290, filed on Dec. 3, 2010.

(51) Int. Cl. C09D 127/06

(52) U.S. Cl. CPC C09D 127/06
USPC 428/220; 264/309; 524/295; 521/145; 523/122

(57) ABSTRACT

A plastisol is disclosed comprising poly(vinyl halide) and a trimellitate plasticizer and a second plasticizer, with the trimellitate plasticizer comprising between about 60 and about 90 weight percent of the total plasticizer content. The plastisol can be made into a polymeric skin using spray molding techniques. The plastisol can be sprayed on a slush mold surface.

### CLAIM OF PRIORITY

This application claims priority from U.S. Provisional Patent Application Ser. No. 61/419,290 bearing Attorney Docket Number 12010008 and filed on Dec. 3, 2010, which is incorporated by reference.

### FIELD OF THE INVENTION

The present invention relates to a plastisol for making spray-molded polyvinyl chloride plastic articles, particularly suited for use in lower temperature conditions as an alternative to a slush molding using plastisol dry blend powders.

### BACKGROUND OF THE INVENTION

U.S. Patent Application Publication 20040054085 (Tansey) describes a problem in the art of making instrument panel coverstocks that are designed to tear at specific locations in order to permit release of airbags from their compartments. Low temperatures can embrittle PVC or PVC alloys used as such coverstock for instrument panels, creating the possibility of fragments of coverstock causing injury to passengers during deployment of an airbag.

Tansey attempts to solve the embrittlement problem by dispersing a melt processible partially crosslinked rubber into a PVC matrix. However, the dispersion of a partially crosslinked rubber into a polymer does not assist the overall thermoplastic nature of the alloy. Indeed, a crosslinked elastomer, i.e., a rubber can inhibit melt processibility of the alloy during the formation of the final form of the thermoplastic product. Also, a rubber can reduce the cold temperature performance of the alloy and elevate the melt viscocity of the polymer.

U.S. Patent Application Publication US 20090239984 (Horton et al.) describes a thermoplastic alloy comprising poly(vinyl halide) and an olefin-based uncrosslinked elastomer having thermoplastic properties. The alloy could be made into a polymeric skin using slush molding techniques.

Others use a dry blend of PVC particles in slush molding to make plastic articles such as instrument panels. These dry blends can not use higher molecular weight resins and higher levels of plasticizers, which assist in low temperature air bag deployment through instrument panel polymer skins, because the resulting dry blend powder is not properly flowable for pouring that powder into a slush mold and melting the powder at a reasonable temperature. Therefore, the dry blend must be used without the higher molecular weight resins and higher levels of plasticizer.

As explained in U.S. Pat. No. 6,129,175 (Tutor et al.), slush-molding is a process where one end of the mold is open. The plastisol is poured into the open end of the mold, and the mold is then cooled from the outside in using cold water. Satisfactory gelation properties are very important in slush molding.

### SUMMARY OF THE INVENTION

The present invention solves the problem by finding a suitable plastisol for making slush molded plastic articles with good low temperature performance properties.

One aspect of the present invention is a spray molded plastic article comprising plastisol liquid fused into a solid after being sprayed in a thin layer on to a surface of a female form mold, wherein the plastisol comprises poly(vinyl halide), a trimellitate plasticizer, and a second plasticizer, wherein the trimellitate plasticizer comprises between about 60 and about 90 weight percent of total plasticizer in the article.

For purposes of this invention, “thin” means from about 0.04 to about 0.30 and preferably from about 0.06 to about 0.20 cm. For purposes of this invention, a “female form mold” can be a slush mold, or any other open cavity mold.

One advantage of the invention is that the plastisol can be processed to form a polymeric skin by spray application of the plastisol onto a female form mold cavity.

### EMBODIMENTS OF THE INVENTION

Poly(Vinyl Halide)

Polyvinyl halides are polymers containing a vinyl moiety and one or more halides bonded thereto. Commercially accepted polyvinyl halides are poly(vinyl chloride) (“PVC”) and chlorinated poly(vinyl chloride) (“CPVC”) due to availability and cost.

PVC is essentially a homopolymer of vinyl chloride with minor amounts of other co-monomers, if any.

Poly(vinyl chloride) comprises polymerized vinyl chloride monomer where preferred polymers are essentially homopolymerized vinyl chloride with little or no copolymerized co-monomers. Useful co-monomers if desired include mono-unsaturated ethylenically unsaturated monomer copolymerizable with vinyl chloride monomer by addition polymerization. Useful co-monomers include other vinyl monomers such as vinyl acetate, ethers, and vinylidene chloride. Other useful co-monomers comprise mono-ethylenically unsaturated monomers including acrylics such as lower alkyl acrylates or methacrylates, acrylic and methacrylic acid, lower alkenyl olefins, vinyl aromatics such as styrene and styrene derivatives, and vinyl esters and ethers. Typical useful commercial co-monomers include acrylonitrile, 2-ethylhexyl acrylate, vinylidene chloride, and isobutyl ether. Useful PVC copolymers can contain from about 0.1% to about 10% or 15%, preferably from about 0.5% to about 5%, by weight of copolymerized co-monomer.

Preferred PVCs are suspension polymerized vinyl chloride although less preferred mass (bulk) polymerized can be useful.

The PVCs of this invention have a K-value from about 50 to about 90 and preferably from about 60 to about 85, as measured by using 0.2 grams of resin in 100 ml of cyclohexanone at 30° C. by ASTM D 1243.

Plasticizer

The poly(vinyl halide) used in the present invention needs to be flexible. Plasticizers are added to poly(vinyl halide) to form flexible thermoplastic polymers.

Plasticizers which perform at lower temperatures, between about −25° C. and about −55° C., are needed for use in the invention because plastic articles such as polymer skins used as instrument panel coverings need to perform at such temperatures in order for air bag deployment to perform properly as a required safety feature in passenger vehicles.

Trimellitate plasticizers are capable of performance at temperatures ranging from about −10° C. to about −30° C. and preferably from about −10° C. to about −25° C. Non-limiting examples of trimellitate plasticizers include trimethyl trimellitate (TMTM), Tri-(2-ethylhexyl) trimellitate (TEHTM-HG or TOTM), Tri-(n-octyl, n-decyl) trimellitate (ATM), Tri-(heptyl,nonyl) trimellitate (LTM), and n-octyl trimellitate (NOTM). Of these plasticizers, NOTM is preferred because of the combination of its low temperature performance and plasticizer absorption during dryblend processing.

PolyOne Corporation of Avon Lake, Ohio is a manufacturer of Synplast™ trimellitate plasticizers and offers for sale the following grades which qualify as low temperature performing plasticizers: Synplast NOTM and Synplast 810TM.

A second plasticizer is needed in the plastisols of the present invention. Plasticizers which perform at the lower temperatures identified above are useful to supplement the trimellitate plasticizer described above because they provide additional low temperature performance to meet cold deployment requirements.

Non-limiting examples of the second plasticizer are a straight chain dibasic acid ester plasticizer (such as dioctyl adipate, or dioctyl sebacate) Dioctyl Azelate (DOZ), Diisodecyl adipate (DIDA), Diisononyl sebacate (DINS), and Diisodecyl sebacate (DIDS).

Commercially available plasticizers are Plasthall DIDS from Hallstar, and Synplast DIDA, Synplast DOS, Synplast DOA from PolyOne, among others.

The amount of trimellitate plasticizer to total plasticizer content is significant to the present invention. Via experimentation with trimellitate and sebacate plasticizers, it has been determined that too little trimellitate plasticizer in the plastisol compound permits exudation, probably sebacate plasticizer. However too much trimellitate plasticizer reduces physical property performance at low temperatures such as −30° C. Table 1 below identifies acceptable, desirable, and preferred ranges of the percentage of trimellitate plasticizer to total plasticizer content in the plastisol compound.

Optional Additives

The compound of the present invention can include conventional plastics additives suitable for plastisols in an amount that is sufficient to obtain a desired processing or performance property for the compound. The amount should not be wasteful of the additive nor detrimental to the processing or performance of the compound. Those skilled in the art of thermoplastics compounding, without undue experimentation but with reference to such treatises as Plastics Additives Database (2004) from Plastics Design Library (www.williamandrew.com), can select from many different types of additives for inclusion into the compounds of the present invention.

Non-limiting examples of optional additives include adhesion promoters; biocides (antibacterials, fungicides, and mildewcides), anti-fogging agents; anti-static agents; bonding, blowing and foaming agents; dispersants; fillers and extenders; fire and flame retardants and smoke suppressants; impact modifiers; initiators; lubricants; micas; pigments, colorants and dyes; plasticizers; processing aids; release agents; silanes, titanates and zirconates; slip and anti-blocking agents; stabilizers; stearates; ultraviolet light absorbers; viscosity regulators; waxes; and combinations of them.

Table 1 shows acceptable, desirable, and preferred ingredients for the plastisols of the present invention.

TABLE 1

| Ingredient (Weight | | | |
|---|---|---|---|
| Percents) | Acceptable | Desirable | Preferred |
| Low Fog PVC Resin | 42-52 | 45-49 | 46.93 |
| Low Fog Barium-Zinc | 0-5 | 3-4 | 3.75 |
| Stabilizer | | | |
| Amine Scavenger | 0-1 | 0.5 | 0.47 |
| Low Temp Trimellitate | 22-37 | 25-35 | 30.03 |
| Plasticizer | | | |
| Polyol | 0-3 | 1-3 | 1.88 |
| Mold Release | | | |
| Low Temp Sebacate | 5-20 | 7-12 | 9.85 |
| Plasticizer | | | |
| UV Stabilizer | 0-3 | 1-3 | 2.35 |
| Epoxidized Soybean Oil | 0-10 | 3-6 | 4.69 |
| Heat Stabilizer | | | |
| Fumed Silica Thickener | 0.0.1 | 0-0.1 | 0.05 |
| Percentage of | 62-88 | 67-83 | 75.3 |
| Trimellitate Plasticizer to | | | |
| Total Plasticizer | | | |

Processing

The preparation of compounds of the present invention is uncomplicated. The compound of the present can be made in a batch operation.

Mixing in a batch process typically occurs in a low shear mixer with a prop-type blade operating at a temperature below 37° C. to avoid plastisol gelation. The mixing speeds range from 60 to 1000 rpm. The output from the mixer is a liquid dispersion ready for later spraying on a mold to form a plastic article.

The plastisol is a thick or viscous liquid, flowable for use in later molding operations.

Subsequent molding techniques are well known to those skilled in the art of thermoplastics polymer engineering. Without undue experimentation but with such references as “Handbook of Molded Part Shrinkage and Warpage”; “Specialized Molding Techniques”; and “Rotational Molding Technology”, all published by Plastics Design Library (www.williamandrew.com), one can make articles of any conceivable shape and appearance using plastisols of the present invention.

After mixing to form the plastisol, preferably, female form molds such as slush molds can be used to form useful plastic articles. Slush molding utilizes an open-end mold design for forming articles (e.g., vehicle instrument panels) as a polymeric skin. One skilled in the art can understand the principles of slush molding by referring to U.S. Pat. No. 6,797,222 (Hausmann et al.) and U.S. Pat. No. 2,736,925; U.S. Pat. No. 3,039,146; European Patent Publication 0 339 222, European Patent Publication 0 476 742 and PCT Patent Publication WO 0207946, in addition to those documents identified above in the Background section.

Briefly, traditional slush molding generally involves the following steps: a) an open-air tank is first filled with a suitable polymer powder in a sufficient quantity and with grain sizes typically below 500 micrometers; b) a mold, usually electroplated with nickel, is then heated to a given temperature; c) the tank and the mold are then coupled in a closed system with suitable coupling means; d) the system is moved so that the tank transfers the powder onto the mold, thus obtaining a uniform layer of partially or completely melted powder which adheres to the mold; e) the closed system is then opened after being brought to the initial conditions again; at this stage the possible excess polymer powder deposits again into the tank and can thus be regenerated; f) the mold can now be heated in order to complete the melting; g) the mold is then cooled with suitable cooling means; and h) the formed sheet is stripped off as a semi-finished product which can then be assembled with a support in order to obtain the finished product in the form of instrument panels, door panels, etc. for the upholstery of cars.

The plastisols of the present invention are particularly suitable to spray the plastisol onto a slush mold surface, otherwise used with slush molding plastisol powders, using an airless spray equipment system. This ability to spray a liquid, as opposed to dispersing a powder into a slush mold, can minimize the “runs” and “drips” which sometimes appear in a plastisol molded plastic article made using the slush process. The spray application also allows for selective skin thickness levels on the part, which allows for lower part weight on non-deployable areas. This is difficult to obtain with a powder.

Therefore, while a slush mold can be used, the molding of a polymeric skin using plastisol of the present invention can significantly reduce the traditional processing steps for slush molding. A preferred method of molding comprises the steps of (a) spraying a surface of a female form mold cavity, preferably a cold nickel slush mold cavity, with plastisol to obtain a layer of plastisol which adheres to the surface of the mold; (b) heating a mold to a temperature of about 160° C. to about 230° C. to gel and fuse the plastisol to form a polymeric skin on the mold; (c) cooling the mold with suitable cooling means; and (d) removing the formed polymeric skin from the mold. Not only is the final polymeric skin product improved but the processing to make the polymeric skin is rendered less complicated.

### USEFULNESS OF THE INVENTION

Plastisols of the present invention are particularly suitable for use in the spraying of thin polymeric film products as an alternative to slush molding for simulated leather, simulated cloth, and other goods used in residential and vehicular upholstery which exhibit improved low temperature and mechanical properties. For example, a “polymeric skin” can be formed using slush molding from plastisols of the present invention. This polymeric skin has a very large aspect ratio of length or width to thickness and can mimic the shape of the mold to create random or repeating patterns of the appearance of grain in leather, wood, or other naturally-occurring items.

### EXAMPLES

Table 2 identifies the ingredients used in the Examples. Table 3 identifies the formulations. Table 4 identifies the processing conditions. Table 5 shows the results of performance testing.

TABLE 2

| Ingredient | Brand | Maker |
|---|---|---|
| Low Fog PVC Resin | Geon 129 × 115 | PolyOne (Avon Lake, OH) |
| Low Fog Barium- | Mark 6708ACM | Crompton (Cleveland, OH) |
| Zinc Stabilizer | | |
| Amine Scavenger | Amfine CPS-55R | Amfine Corp., Allendale, NJ |
| Low Temp | Synplast NOTM | PolyOne |
| Trimellitate | | |
| Plasticizer | | |
| Polyol | Poly-G 2028 | Arch Chemical (Norwalk, CT) |
| Mold Release | | |
| Low Temp Sebacate | Plasthall DIDS | Hallstar (Bedford Park, IL) |
| Plasticizer | | |
| UV Stabilizer | Uvinol Cyano DP | BASF (Charlotte, NC) |
| | Acrylate 3039 | |
| Epoxidized Soybean | Plas-Chek 775 | Ferro Corp. |
| Oil Heat Stabilizer | | |
| Fumed Silica | Aerosil 200 | Evonik Industries |
| Thickener | | |

TABLE 3

| Ingredient | Comp. | Comp. | | Comp. | Comp. | |
|---|---|---|---|---|---|---|
| (PHR) | Ex. A | Ex. B | Ex. 1 | Ex. C | Ex. D | Control |
| Geon | 100 | 100 | 100 | 100 | 100 | PolyOne |
| 129 × 115 | | | | | | PVC |
| | | | | | | Powder - |
| | | | | | | VBX3600 |

TABLE 3

| Ingredient | Comp. | Comp. | | Comp. | Comp. | |
|---|---|---|---|---|---|---|
| (PHR) | Ex. A | Ex. B | Ex. 1 | Ex. C | Ex. D | Control |
| Ferro 6708 | 8 | 8 | 8 | 8 | 8 | |
| CPS-55RD | 1 | 1 | 1 | 1 | 1 | |
| Synplast | 85 | 0 | 64 | 42.5 | 21 | |
| NOTM | | | | | | |
| Poly-G 2028 | 4 | 4 | 4 | 4 | 4 | |
| DIDS | 0 | 85 | 21 | 42.5 | 64 | |
| Uvinol 3039 | 5 | 5 | 5 | 5 | 5 | |
| Plas-Chek 775 | 10 | 10 | 10 | 10 | 10 | |
| Aerosil 200 | 0.1 | 0.1 | 0.1 | 0.1 | 0.1 | |
| Percent of | 100% | 0% | 75.3% | 50% | 24.7% | N/A |
| Trimellitate | | | | | | |
| Plasticizer to | | | | | | |
| Total | | | | | | |
| Plasticizer | | | | | | |

TABLE 4

| Processing | Comparative Examples A-D and | |
|---|---|---|
| Condition | Example 1 | Control |
| Mixing | Low Shear Mixer | Henschel Mixer |
| Equipment | | |
| Mixing Temp. | Below 37° C. | 130° C. |
| Mixing Speed | >500 rpm | 600 rpm |
| Order of | 50 phr of Synplast NOTM initially, | N/a |
| Addition of | then all dry ingredients, and then | |
| Ingredients | once dispersed, add remaining liquid | |
| | components | |
| Form of | Thick liquid | Powder |
| Product After | | |
| Mixing | | |

Each of the Comparative Examples A-D and Example 1 were then tested by molding into a square skin shape having dimensions of 19.05 cm×19.05 cm×0.127 cm (7.5 inch×7.5 inch by 0.050 inch thick having a mass of 50 grams) processed in a oven heat cycle of 204° C. (400° F.) for 12 minutes with the plastisol poured into a cold mold.

The Dry Blend Powder Control was processed using an oven heat cycle, first preheating the 30.48 cm×30.48 cm (12 inch by 12 inch) nickel mold for 10 minutes at 327° C. (620° F.). The mold was removed and the powder was poured onto the mold when the surface temperature reached 230° C. Excess powder was removed after 10 seconds and the backside was post cured at 327° C. (620° F.) for 30 seconds. The part was quenched in a 23° C. water bath for 10 seconds. The finished part had dimensions of 30.48 cm×30.48 cm×0.127 cm (12 inch by 12 inch by 0.05 inches).

The molded parts were then tested using the standardized methods described in Table 5.

TABLE 5

| Performance | Comp. | Comp. | | Comp. | Comp. | |
|---|---|---|---|---|---|---|
| Test | Ex. A | Ex. B | Ex. 1 | Ex. C | Ex. D | Control |
| SAE J1756 | 71 | 52 | 76 | 86 | 68 | 85 |
| 100° C. heat, | | | | | | |
| 23° C. cool 1 | | | | | | |
| hour read | | | | | | |
| SAE J1756 | 90 | 87 | 93 | 95 | 90 | 99 |
| 100° C. heat, | | | | | | |
| 23° C. cool | | | | | | |
| 16 hour read | | | | | | |
| Dynamic | −42.6 | −69.8 | −50.4 | −56.8 | −62.9 | −49.7 |
| Mechanical | | | | | | |
| Analysis | | | | | | |
| Tg E″ max | | | | | | |
| (° C.) | | | | | | |
| Dynamic | −25.9 | −48.7 | −32.7 | −37.7 | −43.4 | −27.0 |
| Mechanical | | | | | | |
| Analysis Tg | | | | | | |
| Tan δ max | | | | | | |
| (° C.) | | | | | | |
| ASTM D638 | 260 | 215 | 294 | 301 | 279 | 138 |
| @ −30° C. | | | | | | |
| Elongation | | | | | | |
| (%) | | | | | | |
| ASTM D638 | 2560 | 2090 | 2670 | 2570 | 2090 | 2900 |
| @ −30° C. | | | | | | |
| Tensile (psi) | | | | | | |
| Exudation of | None | Heavy | None | Slight | Heavy | N/A |
| Plasticizer | | | | | | |
| Percent of | 100% | 0% | 75.3% | 50% | 24.7% | N/A |
| Trimellitate | | | | | | |
| Plasticizer to | | | | | | |
| Total | | | | | | |
| Plasticizer | | | | | | |

The results of Table 5 show that trimellitate plasticizer is required for use in the present invention (Comparative Example B) and must be present in an amount greater than 50% by weight of total plasticizer in order to avoid exudation (Comparative Examples C and D). However, using only trimellitate plasticizer does not result in sufficient results comparable to the control for dynamic mechanical analysis Tg, elongation, and tensile properties (Comparative Example A). Therefore, Example 1 with trimellitate plasticizer comprising about 75% by weight of the total plasticizer present in the plastisol not only avoids exudation but also has physical properties at low temperature meeting or exceeding the physical properties of a dry blend control.

The invention is not limited to the above embodiments. The claims follow.

What is claimed is:

1. A spray molded plastic article comprising:
plastisol liquid fused into a solid after being sprayed into a thin layer on to a surface of a female form mold,
wherein the plastisol comprises poly(vinyl halide), a trimellitate plasticizer, and a second plasticizer,
wherein the trimellitate plasticizer comprises between about 60 and about 90 weight percent of total plasticizer in the article.

2. The article of claim 1, wherein the poly(vinyl halide) comprises poly(vinyl chloride).

3. The article of claim 1, wherein the poly(vinyl halide) is copolymerized with a co-monomer present in an amount ranging from about 0.1 to 15 percent by weight and selected from the group consisting of acrylonitrile, 2-ethylhexyl acrylate, vinylidene chloride, and isobutyl ether.

4. The article of claim 1, wherein the poly(vinyl halide) has a K-value of from about 50 to about 90 as measured using 0.2 grams of poly(vinyl halide) in 100 ml of cyclohexanone at 30° C.

5. The article of claim 1, wherein the trimellitate plasticizer is selected from the group consisting of trimellitate plasticizers include trimethyl trimellitate, Tri-(n-octyl, n-decyl) trimellitate, Tri-(heptyl,nonyl) trimellitate, n-octyl trimellitate (NOTM), Tri-(2-ethylhexyl) trimellitate (TOTM), and combinations thereof.

6. The article of claim 1, wherein the second plasticizer is a sebacate plasticizer, an azelate plasticizer, or an adipate plasticizer, and wherein the trimellitate plasticizer comprises between about 62 and about 88 weight percent of total plasticizer in the article.

7. The article of claim 6, wherein the trimellitate plasticizer comprises between about 67 and about 83 weight percent of total plasticizer in the article.

8. The article of claim 7, wherein the trimellitate plasticizer comprises between about 75 weight percent of total plasticizer in the article.

9. The article of claim 1, further comprising adhesion promoters; biocides (antibacterials, fungicides, and mildewcides), anti-fogging agents; anti-static agents; bonding, blowing and foaming agents; dispersants; fillers and extenders; fire and flame retardants and smoke suppressants; impact modifiers; initiators; lubricants; micas; pigments, colorants and dyes; processing aids; release agents; silanes, titanates and zirconates; slip and anti-blocking agents; stabilizers; stearates; ultraviolet light absorbers; viscosity regulators; waxes; or combinations of them.

10. A method of making the article of claim 1, comprising the steps of:
(a) spraying a surface of a female form mold cavity with plastisol to obtain a layer of plastisol which adheres to the surface of the mold;
(b) heating a mold to a temperature of about 160° C. to about 230° C. to gel and fuse the plastisol to form a polymeric skin on the mold
(c) cooling the mold with suitable cooling means; and
(d) removing the formed polymeric skin from the mold.

11. The process of claim 10, wherein the poly(vinyl halide) comprises poly(vinyl chloride) and wherein the female form mold is a cold nickel slush mold.

12. The process of claim 10, wherein the poly(vinyl halide) is copolymerized with a co-monomer present in an amount ranging from about 0.1 to 15 percent by weight and selected from the group consisting of acrylonitrile, 2-ethylhexyl acrylate, vinylidene chloride, and isobutyl ether.

13. The process of claim 10, wherein the poly(vinyl halide) has a K-value of from about 50 to about 90 as measured using 0.2 grams of poly(vinyl halide) in 100 ml of cyclohexanone at 30° C.

14. The process of claim 10, wherein the trimellitate plasticizer is selected from the group consisting of trimellitate plasticizers include trimethyl trimellitate, Tri-(n-octyl, n-decyl) trimellitate, Tri-(heptyl,nonyl) trimellitate, n-octyl trimellitate (NOTM), Tri-(2-ethylhexyl) trimellitate (TOTM), and combinations thereof.

15. The process of claim 10, wherein the second plasticizer is a sebacate plasticizer, an azelate plasticizer, or an adipate plasticizer, and wherein the trimellitate plasticizer comprises between about 62 and about 88 weight percent of total plasticizer in the article.

16. The process of claim 15, wherein the trimellitate plasticizer comprises between about 67 and about 83 weight percent of total plasticizer in the article.

17. The process of claim 16, wherein the trimellitate plasticizer comprises between about 75 weight percent of total plasticizer in the article.

18. The process of claim 10, further comprising adhesion promoters; biocides (antibacterials, fungicides, and mildewcides), anti-fogging agents; anti-static agents; bonding, blowing and foaming agents; dispersants; fillers and extenders; fire and flame retardants and smoke suppressants; impact modifiers; initiators; lubricants; micas; pigments, colorants and dyes; processing aids; release agents; silanes, titanates and zirconates; slip and anti-blocking agents; stabilizers; stearates; ultraviolet light absorbers; viscosity regulators; waxes; or combinations of them.

19. A polymeric skin made by the process of claim 10, wherein the thickness of the polymeric skin ranges from about 0.06 cm to about 0.30 cm.

20. A polymeric skin comprising the article of claim 1, wherein the thickness of the polymeric skin ranges from about 0.04 cm to about 0.30 cm.
